(19) United States
(12) Patent Application Publication
(10) Pub. No.: US 2019/0295433 A1
(43) Pub. Date: Sep. 26, 2019

(54) Ejection Seat Simulator of Extraction Parachute Type for Experiencing Escape from a Manned Aircraft

(71) Applicant: Man Lai TSE, Hong Kong (HK)

(72) Inventor: Man Lai TSE, Hong Kong (HK)

(21) Appl. No.: 15/964,048

(22) Filed: Apr. 26, 2018

(30) Foreign Application Priority Data
Mar. 26, 2018 (CN) 201810254118.5

(51) Int. Cl. G09B 9/08; G09B 9/14

(52) U.S. Cl. CPC G09B 9/085; G09B 9/14

(57) ABSTRACT

The invention relates to an ejection seat simulator of extraction parachute type for experiencing escape from a manned aircraft which includes a base, a guide rail, a power device, a somatosensory seat, a head-mounted display, and a pair of control pull ring. A box, a controller and an air pump are disposed on the base. The power device includes a first support plate, a hydraulic rod, a guide wheel set, a first shaft, a connecting plate, a motor and a gear set. The control pull ring includes a ring body and a pull rope. The ring body is inlaid with a control button, a wireless transmission module, a tension sensor and a buffer spring. The ejection seat simulator of extraction parachute type for experiencing escape from a manned aircraft of the invention has advantages of having reasonable and simple structure, easy to operate, low price, safe and reliable, strong authenticity, high intelligence, which effectively solves the problem of being unable to experience or train escape in ejection seats in the real manned aircrafts.

### FIELD OF THE INVENTION

The invention relates to the field of virtual reality devices, and in particular to an ejection seat simulator of extraction parachute type for experiencing escape from a manned aircraft.

### BACKGROUND

In the known technology, most of manned aircrafts are equipped with ejection seats. Ejection seats are seats for manned aircraft drivers. When a manned aircraft is in distress, the power device under the seat ejects the driver out of the aircraft cabin, and the parachute is opened to enable the driver to safely land the seat-type lifesaving device.

All countries in the world strictly control the manned aircrafts. After using the ejection seat, no driver is in the manned aircraft and the manned aircrafts will immediately crash. Therefore, no matter whether ordinary people or aircraft drivers cannot experience the ejection seats. Using ejection seats to experience being ejected from manned aircrafts on the ground is different from using ejection seats in the real manned aircrafts. Therefore, it is necessary to develop a simulator that simulates an ejection seat being ejected from a real aircraft and landing on the ground.

### SUMMARY OF THE INVENTION

The technical problem to be solved is to overcome the above-mentioned deficiency by providing an ejection seat simulator of extraction parachute type for experiencing escape from a manned aircraft. It has advantages of having reasonable and simple structure, easy to operate, low price, safe and reliable, strong authenticity, high intelligence, which effectively solves the problem of being unable to experience or train escape in ejection seats in the real manned aircrafts.

The technical solution of the present invention is to provide an ejection seat simulator of extraction parachute type for experiencing escape from a manned aircraft which includes a base, a guide rail, a power device, a somatosensory seat, a head-mounted display, and a pair of control pull ring. The base is provided with a box, a controller and an air pump. A plurality of vent holes are provided on an upper cover of the box. The inner cavity of the box communicates with the air pump, and the air pump is electrically connected to the controller.

The guide rail is an I-shaped structure with sliding chutes on both sides, and is fixed vertically on the base along the traveling direction of the sliding chute.

The power device includes a first support plate, a hydraulic rod, a guide wheel set, a first shaft, a connecting plate, a motor and a gear set. Two ends of the hydraulic rod fixedly connect to the base and the first support plate, respectively. The guide wheel set is rotatably connected to a second shaft fixedly arranged on the first support plate. The guide wheel set abuts with the sliding chutes on the guide rail.

The motor is fixed on the first support plate. A main shaft of the motor is connected to the gear set. One end of the first shaft is connected to the gear set. The other end of the first shaft passes through a bearing on the support plate, and connects to the connecting plate via a universal shaft joint.

A plurality of first magnetic proximity switches are disposed on the guide rail. A first magnet is disposed on the guide wheel set. A second magnetic proximity switch is disposed on the first support plate. Correspondingly, a plurality of second magnets are circumferentially arranged on the first shaft.

A third support plate is disposed on the top of the guide rail. A plurality of illuminating lamps and a spray head are disposed on the third support plate. The spray head is connected with the air pump.

The control pull ring includes a ring body and a pull rope. An upper end of the pull rope is fixed on the third support plate. The ring body is inlaid with a control button, a wireless transmission module, a tension sensor and a buffer spring. One end of the tension sensor is fixed in the inner cavity of the ring body. The other end of the tension sensor is connected to a lower end of the pull rope. A buffer spring is arranged between the tension sensor and the ring body.

In a further embodiment, the somatosensory seat includes a second support plate fixedly connected to the connecting plate, a cushion disposed on the second support plate, and a safety pressure bar. The cushion is provided with a speaker. One end of the safety pressure bar is hinged with the second support plate. The other end of the safety pressure bar is connected to the second support plate via a safety belt.

In a further embodiment, a plurality of airbags interconnected with the air pump are disposed between the support plate and the cushion. A binding belt for binding the feet is also disposed on the second support plate.

In a further embodiment, an electric cylinder is fixed on the second support plate, and a foot pedal is fixed on a main shaft of the electric cylinder.

In a further embodiment, a first pressure sensor is disposed on the pedal.

In a further embodiment, a buffer rubber pad is disposed on the safety pressure bar, and a second pressure sensor is disposed between the buffer rubber pad and the safety pressure bar.

In a further embodiment, the second pressure sensor is a thin plate type pressure sensor.

In a further embodiment, the somatosensory seat is provided with a vibration motor.

In a further embodiment, the motor, the illuminating lamp, the second magnetic proximity switch, the electric cylinder, the first pressure sensor, the second pressure sensor, the vibration motor, the first magnetic proximity switch, the head-mounted display are electrically connected to the controller, respectively.

In a further embodiment, the first shaft is provided with a connecting member and a plurality of steering cylinders disposed circumferentially along the central axis of the first shaft. Two ends of the steering cylinder are hinged with the connecting member and the connecting plate, respectively.

The technical effect of the invention is to provide an ejection seat simulator of extraction parachute type for experiencing escape from a manned aircraft which includes a base, a guide rail, a power device, a somatosensory seat, a head-mounted display, and a pair of control pull ring. An air pump disposed on the base is used to simulate the change of air flow during the ejection through a box and a spray head. The guide rail is vertically disposed on the base. The power device pushes the somatosensory seat to move upside and downside, roll over and tilt to simulate the change of posture during ejection and landing. An airbag is used to simulate the stress on the human body due to the weight loss and overweight while the human body is fixed in somatosensory seat. The control pull ring is used to simulate the operation of the parachute during landing. All the operations are processed and transmitted to the head-mounted display. It has advantages of having reasonable and simple structure, easy to operate, low price, safe and reliable, strong authenticity, high intelligence, which effectively solves the problem of being unable to experience or train escape in ejection seats in the real manned aircrafts.

### BRIEF DESCRIPTION OF THE DRAWINGS

The invention is illustrated by the following figures and embodiments.

FIG. 1 shows a schematic diagram of whole structure of an ejection seat simulator of extraction parachute type for experiencing escape from a manned aircraft in accordance with an embodiment.

FIG. 2 shows a top view of schematic diagram of an ejection seat simulator of extraction parachute type for experiencing escape from a manned aircraft in accordance with an embodiment.

FIG. 3 shows a schematic diagram of the connection between a somatosensory seat and a power device of an ejection seat simulator of extraction parachute type for experiencing escape from a manned aircraft in accordance with an embodiment.

FIG. 4 shows an enlarged schematic diagram of a somatosensory seat of an ejection seat simulator of extraction parachute type for experiencing escape from a manned aircraft in accordance with an embodiment.

FIG. 5 shows a schematic diagram of a control pull ring of a somatosensory seat of an ejection seat simulator of extraction parachute type for experiencing escape from a manned aircraft in accordance with an embodiment.

The reference numbers of the figures are as follows:

1: base; 11: box; 111: upper cover; 12: controller; 13: air pump; 2: guide rail; 21: first magnetic proximity switch; 22: third support plate; 221: immolating lamp; 222: spray head; 3: power device; 31: first support plate; 311: bearing; 312: second magnetic proximity switch; 313: second shaft; 32: hydraulic rod, 33: guide wheel set, 331: first magnet; 34: first shaft; 341: second magnet; 342: universal shaft joint; 35: connecting plate; 36: motor; 37: gear set; 38: connecting member; 39: steering cylinder; 4: somatosensory seat; 41: second support plate; 42: cushion; 421: speaker; 43: airbag; 44: electric cylinder; 441: first pressure sensor; 442: pedal; 45: safety pressure bar; 451: safety belt; 452: binding belt; 46: vibration motor; 47: buffer rubber pad; 471: second pressure sensor; 5: head-mounted display; 6: control pull ring; 60: ring body; 61: control button; 62: wireless transmission module; 63: tension sensor; 64: buffer spring; 65: pull rope.

### DETAILED DESCRIPTION

The invention is illustrated in accordance with figures. The figures as simplified diagrams demonstrate the basic structures of the apparatus of embodiments of the invention. Thus, the invention is not limited to the figures.

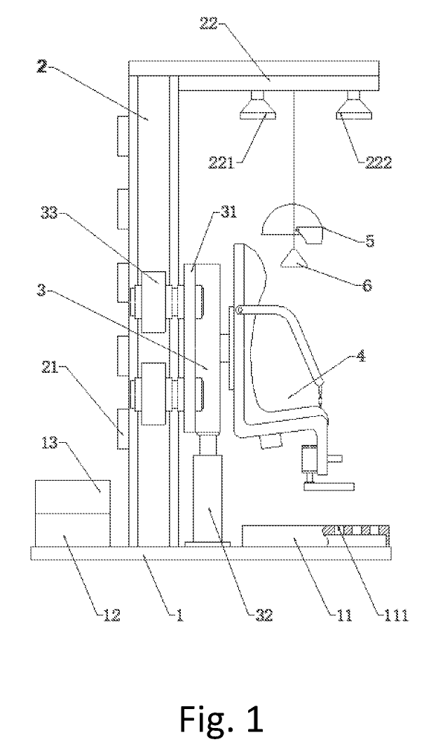

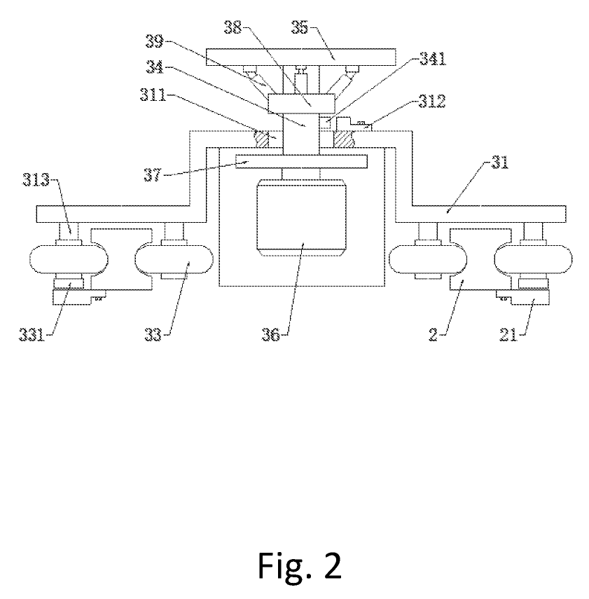

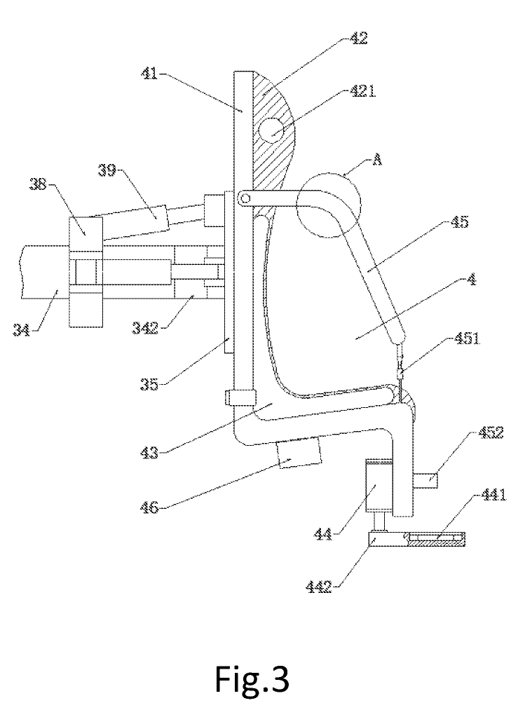

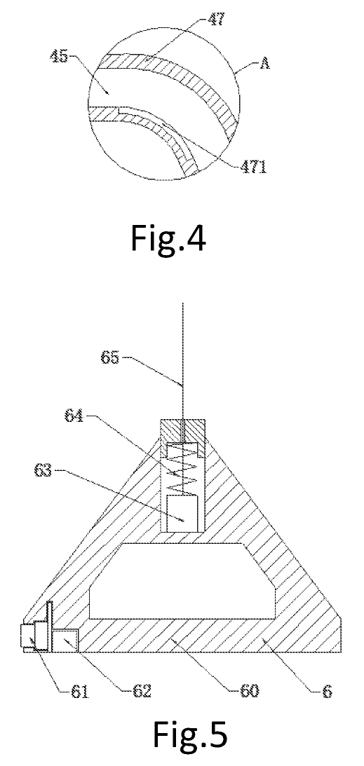

As shown in FIGS. 1-5, an ejection seat simulator of extraction parachute type for experiencing escape from a manned aircraft includes a base 1, a guide rail 2, a power device 3, a somatosensory seat 4, a head-mounted display 5 with an accelerometer and a gyroscope, and a pair of control pull ring 6. The base 11 is provided with a box 11, a controller 12 and an air pump 13. A plurality of vent holes are provided on an upper cover 111 of the box 11. The inner cavity of the box 11 communicates with the air pump 13, and the air pump 13 is electrically connected to the controller 12. The controller 12 controls the air pump 13 to supply air into the box 11, and the air is sprayed out through the vent holes to simulate the air flow during the landing of the ejection seat.

The guide rail 2 is an I-shaped structure with sliding chutes on both sides, and is fixed vertically on the base 1 along the traveling direction of the sliding chute.

The power device 3 includes a first support plate 31, a hydraulic rod 32, a guide wheel set 33, a first shaft 34, a connecting plate 35, a motor 36 and a gear set 37. Two ends of the hydraulic rod 32 fixedly connect to the base 1 and the first support plate 31, respectively. The guide wheel set 33 is rotatably connected to a second shaft 313 fixedly arranged on the first support plate 31. The guide wheel set 33 abuts with the sliding chutes on the guide rail 2.

The motor 36 is fixed on the first support plate 31. A main shaft of the motor 36 is connected to the gear set 37. One end of the first shaft 34 is connected to the gear set 37. The other end of the first shaft 34 passes through a bearing 311 on the support plate, and connects to the connecting plate 35 via a universal shaft joint 342.

The first shaft 34 is provided with a connecting member 38 and a plurality of steering cylinders 39 disposed circumferentially along the central axis of the first shaft 34. Two ends of the steering cylinder 39 are hinged with the connecting member 38 and the connecting plate 35, respectively.

The first supporting plate 31, the hydraulic rod 32, the first shaft 34, the connecting plate 35, the motor 36, and the gear set 37 can move up and down along the guide rail 2 under the action of the hydraulic rod 32 and the guide wheel set 33. The first shaft 34 drives the connecting plate 35 to rotate under the action of the motor 36. The steering cylinder 39 disposed on the first shaft 34 is used to adjust the orientation of the connecting plate 35. As the connecting plate 35 directly connects to the somatosensory seat 4, the hydraulic rod 32, the first shaft 34 and the steering cylinder 39 indirectly control the up-and-down motion and the tilting motion of the somatosensory seat 4.

A plurality of first magnetic proximity switches 21 are disposed on the guide rail 2. A first magnet 331 is disposed on the guide wheel set 33. A second magnetic proximity switch 312 is disposed on the first support plate 31. Correspondingly, a plurality of second magnets 341 are circumferentially arranged on the first shaft 34. The first magnetic proximity switch 21 and the first magnet 331 cooperate with each other to determine the height of the guide wheel set 33 from the ground, indirectly obtain the distance of other components of the power device 3 from the ground, and send data to the controller 12. Likewise, the second magnetic proximity switch 312 and the second magnet 341 cooperate with each other to measure the rotation angle of the first shaft 34 and send data to the controller 12 for data processing.

A third support plate 22 is disposed on the top of the guide rail 2. A plurality of illuminating lamps 221 and a spray head 222 are disposed on the third support plate 22. The spray head 222 is connected with the air pump 13. The spray head 222 is used to simulate downward air flow generated when the ejection seat is ejected upward.

The control pull ring 6 includes a ring body 60 and a pull rope 65. An upper end of the pull rope 65 is fixed on the third support plate 22. The ring body 60 is inlaid with a control button 61, a wireless transmission module 62, a tension sensor 63 and a buffer spring 64. One end of the tension sensor 63 is fixed in the inner cavity of the ring body 60. The other end of the tension sensor 63 is connected to a lower end of the pull rope 65. A buffer spring 64 is arranged between the tension sensor 63 and the ring body 60. The function of the control pull ring 6 is to simulate the operation to the parachute during the landing of the ejection seat, such as pulling the pull ring to control the opening time of the parachute, pulling the pull ring to control the direction of the parachute, pressing the control button 61 to cut off the parachute rope, etc. The data generated from the control button 61 in the control pull ring 6 and the tension sensor 63 transmits to the controller 12 for data processing via the wireless transmit module 62.

The somatosensory seat 4 includes a second support plate 41 fixedly connected to the connecting plate 35, a cushion 42 disposed on the second support plate 41, and a safety pressure bar 45. The cushion 42 is provided with a speaker 421. One end of the safety pressure bar 45 is hinged with the second support plate 41. The other end of the safety pressure bar 45 is connected to the second support plate 41 via a safety belt 451.

A plurality of airbags 43 interconnected with the air pump are disposed between the second support plate 41 and the cushion 42. A binding belt 452 for binding the feet is also disposed on the second support plate 41. An electric cylinder 44 is fixed on the second support plate 41, and a foot pedal 442 is fixed on a main shaft of the electric cylinder 44. A first pressure sensor 441 is disposed on the pedal 442. A buffer rubber pad 47 is disposed on the safety pressure bar 45, and a second pressure sensor 471 for determining the pressure of upper limb relative to the safety pressure bar 45 is disposed between the buffer rubber pad 47 and the safety pressure bar 45. The data of the second pressure sensor 471 transmits to the controller 12 for data analysis. The second pressure sensor 471 is a thin plate type pressure sensor. The somatosensory seat 4 is provided with a vibration motor 46 underneath.

The airbag 43 is mainly used to simulate to the feeling of pressure on the upper limb of the human body during the weight loss and overweight environment. The airbag 43 should contain a certain amount of air before use. When the ejection seat is simulated to be ejected upward, the power device 3 accelerates to move upward along the guide rail 2 to generate the real feeling of overweight, while the airbag 43 exhausts air outwards. The feeling of pressure on the upper limb relative to the safety pressure bar 45 is significantly reduced. The power device 3 generates to continuous overweight after receiving the information of movement. When the ejection seat is simulated to land, the power device 3 accelerates to move downward along the guide rail 2 to generate the real feeling of weightlessness, the airbag 43 is inflated. When the power device 3 rises to a certain height, the airbag 43 is filled with a certain amount of air. Since the airbag 43 has a soft texture, the pressure against the upper limb from the safety pressure bar 45 is far greater than other parts. This will generate continuous feeling of weightlessness. The electric cylinder 44 drives the pedal 442 to move upward and downward to generate or not generate support to the lower limb of the human body to enhance the feeling of weightlessness or being overweight. The pedal 442 moves upward to support the lower limb of the human body during overweight. The pedal 442 moves downwards to make the lower limb of the human body lose support during weightlessness. The vibration motor 46 is used to simulate vibration.

The head mounted display 5 is provided with a sensor, a second magnetic proximity switch 312, a first pressure sensor 441, a second pressure sensor 471, a first magnetic proximity switch 21, a control button 61 of the control pull ring 6, and the tension sensor 63 which are respectively wire or wireless connected to the controller 12. The data transmitted to the controller 12 is processed and analyzed. The controller 12 sends an instruction to control the hydraulic rod 32, the motor 36, the illumination lamps 221, the electric cylinder 44, the vibration motor 46 and the head-mounted display 5.

The ejection seat simulator of extraction parachute type for experiencing escape from a manned aircraft of the invention includes a base, a guide rail, a power device, a somatosensory seat, a head-mounted display, and a pair of control pull ring. An air pump disposed on the base is used to simulate the change of air flow during the ejection through a box and a spray head. The guide rail is vertically disposed on the base. The power device pushes the somatosensory seat to move upside and downside, roll over and tilt to simulate the change of posture during ejection and landing. An airbag is used to simulate the stress on the human body due to the weight loss and overweight while the human body is fixed in somatosensory seat. The control pull ring is used to simulate the operation of the parachute during landing. All the operations are processed and transmitted to the head-mounted display. It has advantages of having reasonable and simple structure, easy to operate, low price, safe and reliable, strong authenticity, high intelligence, which effectively solves the problem of being unable to experience or train escape in ejection seats in the real manned aircrafts.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An ejection seat simulator of extraction parachute type for experiencing escape from a manned aircraft, comprising: a base 1, a guide rail 2, a power device 3, a somatosensory seat 4, a head-mounted display 5 and a pair of control pull ring 6,
wherein the guide rail 2 is an I-shaped structure with sliding chutes on both sides, and is fixed vertically on the base 1 along the traveling direction of the sliding chute;
wherein the power device 3 includes a first support plate 31, a hydraulic rod 32, a guide wheel set 33, a first shaft 34, a connecting plate 35, a motor 36 and a gear set 37; two ends of the hydraulic rod 32 fixedly connect to the base 1 and the first support plate 31, respectively; the guide wheel set 33 is rotatably connected to a second shaft 313 fixedly arranged on the first support plate 31; the guide wheel set 33 abuts with the sliding chutes on the guide rail 2;
wherein the motor 36 is fixed on the first support plate 31; a main shaft of the motor 36 is connected to the gear set 37; one end of the first shaft 34 is connected to the gear set 37; the other end of the first shaft 34 passes through a bearing 311 on the support plate, and connects to the connecting plate 35 via a universal shaft joint 342;
wherein a plurality of first magnetic proximity switches 21 are disposed on the guide rail 2; a first magnet 331 is disposed on the guide wheel set 33; a second magnetic proximity switch 312 is disposed on the first support plate 31; a plurality of second magnets 341 are circumferentially arranged on the first shaft 34;
wherein a third support plate 22 is disposed on the top of the guide rail 2; a plurality of illuminating lamps 221 and a spray head 222 are disposed on the third support plate 22; the spray head 222 is connected with the air pump 13; and
wherein the control pull ring 6 includes a ring body 60 and a pull rope 65; an upper end of the pull rope 65 is fixed on the third support plate 22; the ring body 60 is inlaid with a control button 61, a wireless transmission module 62, a tension sensor 63 and a buffer spring 64; one end of the tension sensor 63 is fixed in the inner cavity of the ring body 60; the other end of the tension sensor 63 is connected to a lower end of the pull rope 65; a buffer spring 64 is arranged between the tension sensor 63 and the ring body 60.

2. The ejection seat simulator of extraction parachute type for experiencing escape from a manned aircraft of claim 1, wherein the somatosensory seat 4 includes a second support plate 41 fixedly connected to the connecting plate 35, a cushion 42 disposed on the second support plate 41, and a safety pressure bar 45; the cushion 42 is provided with a speaker 421; one end of the safety pressure bar 45 is hinged with the second support plate 41; the other end of the safety pressure bar 45 is connected to the second support plate 41 via a safety belt 451.

3. The ejection seat simulator of extraction parachute type for experiencing escape from a manned aircraft of claim 2, wherein a plurality of airbags 43 interconnected with the air pump 13 are disposed between the second support plate 41 and the cushion 42, and a binding belt 452 for binding the feet is also disposed on the second support plate 41.

4. The ejection seat simulator of extraction parachute type for experiencing escape from a manned aircraft of claim 2, wherein an electric cylinder 44 is fixed on the second support plate 41, and a foot pedal 442 is fixed on a main shaft of the electric cylinder 44.

5. The ejection seat simulator of extraction parachute type for experiencing escape from a manned aircraft of claim 4, wherein a first pressure sensor 441 is disposed on the pedal 442.

6. The ejection seat simulator of extraction parachute type for experiencing escape from a manned aircraft of claim 2, wherein a buffer rubber pad 47 is disposed on the safety pressure bar 45, and a second pressure sensor 471 is disposed between the buffer rubber pad 47 and the safety pressure bar 45.

7. The ejection seat simulator of extraction parachute type for experiencing escape from a manned aircraft of claim 6, wherein the second pressure sensor 471 is a thin plate type pressure sensor.

8. The ejection seat simulator of extraction parachute type for experiencing escape from a manned aircraft of claim 2, wherein the somatosensory seat 4 is provided with a vibration motor 46 underneath.

9. The ejection seat simulator of extraction parachute type for experiencing escape from a manned aircraft of claim 7, wherein the motor 36, the illuminating lamp 221, the second magnetic proximity switch 312, the electric cylinder 44, the first pressure sensor 441, the second pressure sensor 471, the vibration motor 46, the first magnetic proximity switch 21, the head-mounted display 5 are electrically connected to the controller 12, respectively.

10. The ejection seat simulator of extraction parachute type for experiencing escape from a manned aircraft of claim 1, wherein the first shaft 34 is provided with a connecting member 38 and a plurality of steering cylinders 39 disposed circumferentially along the central axis of the first shaft 34; two ends of the steering cylinder 39 are hinged with the connecting member 38 and the connecting plate 35, respectively.

11. The ejection seat simulator of extraction parachute type for experiencing escape from a manned aircraft of claim 3, wherein an electric cylinder 44 is fixed on the second support plate 41, and a foot pedal 442 is fixed on a main shaft of the electric cylinder 44.

12. The ejection seat simulator of extraction parachute type for experiencing escape from a manned aircraft of claim 11, wherein a first pressure sensor 441 is disposed on the pedal 442.
